(19) United States
(12) Patent Application Publication
(10) Pub. No.: US 2014/0112131 A1
(43) Pub. Date: Apr. 24, 2014

(54) SWITCH, COMPUTER SYSTEM USING SAME, AND PACKET FORWARDING CONTROL METHOD

(71) Applicant: Hitachi, Ltd., Tokyo (JP)

(72) Inventors: Takashi Todaka, Tokyo (JP); Yoshiki Murakami, Tokyo (JP); Junji Yamamoto, Tokyo (JP)

(73) Assignee: Hitachi, Ltd., Tokyo (JP)

(21) Appl. No.: 14/126,798

(22) PCT Filed: Jun. 17, 2011
(86) PCT No.: PCT/JP2011/063975

§ 371 Date: Dec. 16, 2013

(51) Int. Cl. H04L 12/851

(52) U.S. Cl. CPC H04L 47/2433; H04L 47/2441
USPC 370/230

(57) ABSTRACT

Provided are a PCIe switch provided with a bandwidth control function, and a computer system using the same. The PCIe switch has: input ports to which are connected initiators that generate packets; output ports to which are connected targets that are the transmission destinations of the packets; and an output port adjustment section intervening between the input ports and the output ports, for adjusting the output of packets from the input ports to the output ports. The input ports further have a bandwidth control section that establishes bandwidth limit values beforehand for each of a plurality of divided groups; classifies packets transmitted from the initiators into any of the plurality of groups according to a predetermined rule; and outputs the classified packets to the output adjustment section, on the basis of the bandwidth limit values.

### TECHNICAL FIELD

The present invention relates to a switch, a computer system using the same, and a packet forwarding control method, and in particular to a computer system configured by using a PCIe switch connecting a plurality of computers and a plurality of input/output devices (each of which is simply, called “I/O”), and a packet forwarding control method in a PCIe switch.

### BACKGROUND ART

PCI Express (hereinafter, called “PCIe) is one of bus standards used for connecting respective components within a computer system and worked out according to PCI-SIG, and it is characterized by adopting a serial forwarding interface and a full-duplex communication system. Data forwarding in the PCIe is performed by dividing data into a plurality of packets, and address information about transmission/reception destination and the like are added to each packet. By diving the data to perform data forwarding, occupation of the bus can be avoided, so that the bus can be utilized efficiently.

The PCIe is mainly composed of Root Complex (hereinafter, called “RC”), Endpoint (hereinafter, called “EP”), and a PCIe switch. The RC connects a processor and a PCIe bus and is generally embedded in an I/O controller within a computer system. The EP functions as a terminal of the PCIe bus and is generally embedded in the I/O. The PCIe switch expands the number of PCIe buses to realize a function for relaying a packet. The PCIe switch is composed of a plurality of PCI-PCI bridges and has a function of making determination about availability of passage of a packet.

In a PCIe specification, in order to enhance a usage efficiency of a resource, Single Root I/O Virtualization and Sharing Specification (hereinafter, called “SR-IOV) or Multi-Root I/O Virtualization and Sharing Specification (hereinafter, called “MR-IOV) realizing virtualization of I/O is worked out. One EP can be shared from a plurality of virtual machines or a plurality of RCs in conformity with the SR-IOV or the MR-IOV. By sharing the EP, traffic of packets is increased in the EP.

In the PCIe specification, Virtual Channel (hereinafter, called “VC”) and Traffic Class (hereinafter, called “TC”) are defined. An independent flow control is performed between different VCs, and the TC is associated with a specific VC to determine priority of services to traffic. By using the VC or the TC, it is tried to realize the Quality of Service (QoS).

Also, in the PCIe specification, it is possible to perform priority control of packets using the VC or the TC. However, when a plurality of packets exists and high priority or low priority is allocated to each packet using the VC or the TC, such a situation occurs that only packets having the high priority are served but when packets having the low priority are served cannot be predicted.

In a communication field, there are various proposals regarding priority control or forwarding control for packets. For example, regarding the priority control for packets, a relay communication apparatus which provides priority to a packet forwarded from a selector section for performing forwarding destination switching of a packet in a QoS control section to forward the packet provided with the priority to a global network transmission/reception section is disclosed in Patent Literature 1.

Also, regarding a limit control of a traffic flow rate in packet forwarding, a bandwidth limit method and a switch where in packet forwarding between a plurality of terminals connected by a ring-like network, switches A and B connected to terminals A and B in a packet source detect traffic flow rates from the terminals A and B and a traffic flow rate flowing within the ring-like network to provide bandwidth information regarding the bandwidths of the traffic flow rates to a switch C connected to a terminal C of a transmission destination, the switch C provided with the bandwidth information calculates bandwidths which can be allocated to the switches A and B based upon the bandwidth information and transmits the calculation result to the switches A and B as bandwidth control information, and the switches A and B limit the traffic flow rate to the terminal C on the basis of the bandwidth limit information are disclosed in Patent Literature 2.

### CITATION LIST

### Patent Literature

PTL 1: Japanese Patent Application Laid-Open No. 2011-29788
PTL 2: Japanese Patent Application Laid-Open No. 2006-157592

### SUMMARY OF INVENTION

### Technical Problem

In a case of a priority control where the high priority or the low priority is allocated to each packet using the VC or the TC in such a PCIe specification as described above, when a configuration where the EP is shared by a plurality of virtual machines or a plurality of RCs is adopted, a bandwidth performance which the EP can be expected to have by an application is not satisfied, which may result in reduction in performance of the entire system. For example, a memory read packet is allocated with a low priority as the PCIe packet and only other packets having the high priority are processed, so that the packets having the low priority are not executed, which results in occurrence of such a problem that timeout is detected at a memory read issuance source.

Further, for utilizing a plurality of VCs, such a constraint that all of RCs, EPs and PCIe switches connecting the RC and the EP must have queues and buffers independent for the plurality of VCs, and a control circuit for controlling them occurs. Furthermore, in the limit control of the traffic flow rate in Patent Literature 2, in order to preform notification of bandwidth information about the bandwidth of the detected traffic flow rate, a circuit for newly generating a special packet is required, which results in increase in hardware.

The present invention lies in realization of a PCIe switch provided with a bandwidth control function.

Further, the present invention lies in that setting a bandwidth usable between applications sharing an EP to optimize data forwarding performance of the entire system.

### Solution to Problems

A switch according to the present invention is preferably a switch that connects initiators that generate packets and targets that are transmission destinations of the packets, the switch comprising: input ports to which the initiators are connected; output ports to which the targets are connected; and an output port adjustment section intervening between the input ports and the output ports, for adjusting the output of packets from the input ports to the output ports, wherein the input ports further have a bandwidth control section that establishes bandwidth limit values beforehand for each of a plurality of divided groups; classifies packets transmitted from the initiators into any of the plurality of groups according to a predetermined rule; and outputs the classified packets to the output port adjustment section, on the basis of the bandwidth limit values.

A switch in a preferable example of the present invention is a switch based upon a PCIe specification, which connects initiators that generate packets and targets that are transmission destinations of the packets, the switch comprising:

a plurality of input ports to which the initiators are connected; a plurality of output ports to which the targets are connected; and an output port adjustment section intervening between the input ports and the output ports, for adjusting the output of packets from the input ports to the output ports, wherein

each of the plurality of input ports comprises:

a group determination section that classifies PCIe packets transmitted from the initiators into any of a plurality of groups according to a predetermined rule;

a plurality of queuing sections corresponding to the respective groups, for storing the PCIe packets determined by the group determination section;

a plurality of flow rate comparison section corresponding to the respective groups, for assigning priority to the PCIe packets in the queuing sections on the basis of bandwidth control values established beforehand to perform bandwidth control; and

a queue output adjustment section that performs adjustment of the PCIe packets outputted from the queuing section on the basis of the priority assigned by the flow rate comparison section, and wherein

the PCIe packets outputted from the queue output adjustment section are forwarded to the output port adjustment section.

A computer system according to the present invention is preferably a computer system comprising: a switch based upon a PCIe specification and having a plurality of input ports, a plurality of output ports, and an output port adjustment section that performs adjustment of outputs of packets from the input ports to the output ports;

a plurality of computers connected to the input ports and the output ports and serving as initiators that generate packets or targets that are transmission destinations of the packets; and

a plurality of I/O devices connected to the input ports and the output ports and serving as initiators that generate packets or targets that are transmission destinations of the packets, wherein

the input ports of the switch have a bandwidth control section that establishes bandwidth limit values beforehand for each of a plurality of divided groups, classifies packets transmitted from the initiators into any of the plurality of groups according to a predetermined rule, and outputs the classified packets to the output port adjustment section, on the basis of the bandwidth limit values.

In a preferred example, the computer is a computer that does not have a bandwidth control function, and the I/O device is a device that does not have a bandwidth control function.

Further, in a preferred example, the computer system is a computer system configured such that a pair of input port and output port of the switch are further connected with another switch having a configuration similar to that of the former switch and a plurality of computers and a plurality of I/O devices are connected to a plurality of input ports and a plurality of output port of the another switch.

A packet forwarding control method according to the present invention is preferably a PCIe packet forwarding control method in a switch based upon a PCIe specification and having a plurality of input ports to which are connected initiators that generate packets, a plurality of output port to which are connected targets which are transmission destinations of the packets, and an output port adjustment section intervening between the input ports and the output ports, for adjusting output of packets from the input ports to the output ports, the method comprising:

a group determination step of classifying PCIe packets transmitted from the initiators into any of a plurality of groups according to a predetermined rule;

a step of storing the PCIe packets determined at the group determination step into a storage means;

a step of assigning priorities to the PCIe packets in the storage means on the basis of bandwidth limit values established beforehand to perform bandwidth control;

a step of performing adjustment of the PCIe packets outputted from the storage means on the basis of the assigned priorities; and

a step of transmitting the adjusted PCIe packets from the output ports to targets that are the transmission destinations via the output port adjustment section.

### Advantageous Effects of Invention

According to the present invention, a PCIe switch provided with a bandwidth control function can be realized. Thereby, bandwidths can be allocated to respective destinations of data forwarding in the PCIe switch. As a result, a bandwidth usable between applications sharing an EP can be set, so that a data forwarding performance of the entire system can be optimized.

Further, since bandwidth control can be performed by the PCIe switch provided with a bandwidth control function, it becomes possible to connect an existing computer or device that is not provided with a bandwidth control function to the switch in a computer system connecting a plurality of computers and a plurality of devices via the switch. In the PCIe switch and the computer system using the same according to the present invention, a RC and an EP are not required to have a function corresponding to the VC, so that a configuration of a bandwidth control-adjusted computer system is made easy.

### BRIEF DESCRIPTION OF DRAWINGS

FIG. 1 is a configuration diagram showing of a PCIe switch according to an embodiment;

FIG. 2 is a diagram showing a configuration example of a priority determination circuit in the PCIe switch according to an embodiment;

FIG. 3 is a diagram showing a time relationship between a priority determination term and priority determination in an embodiment;

FIG. 4 is a diagram showing one example of a packet handled in the PCIe switch of an embodiment;

FIG. 5 is a diagram showing an example of priority determination in an embodiment;

FIG. 6 is a configuration diagram of a computer system provided with a PCIe switch according to another embodiment; and

FIG. 7 is a configuration diagram of a computer system provided with PCIe switches in a multistage fashion according to another embodiment.

### DESCRIPTION OF EMBODIMENTS

Preferred examples of a PCIe switch will be described below with reference to the drawings.

### Embodiment 1

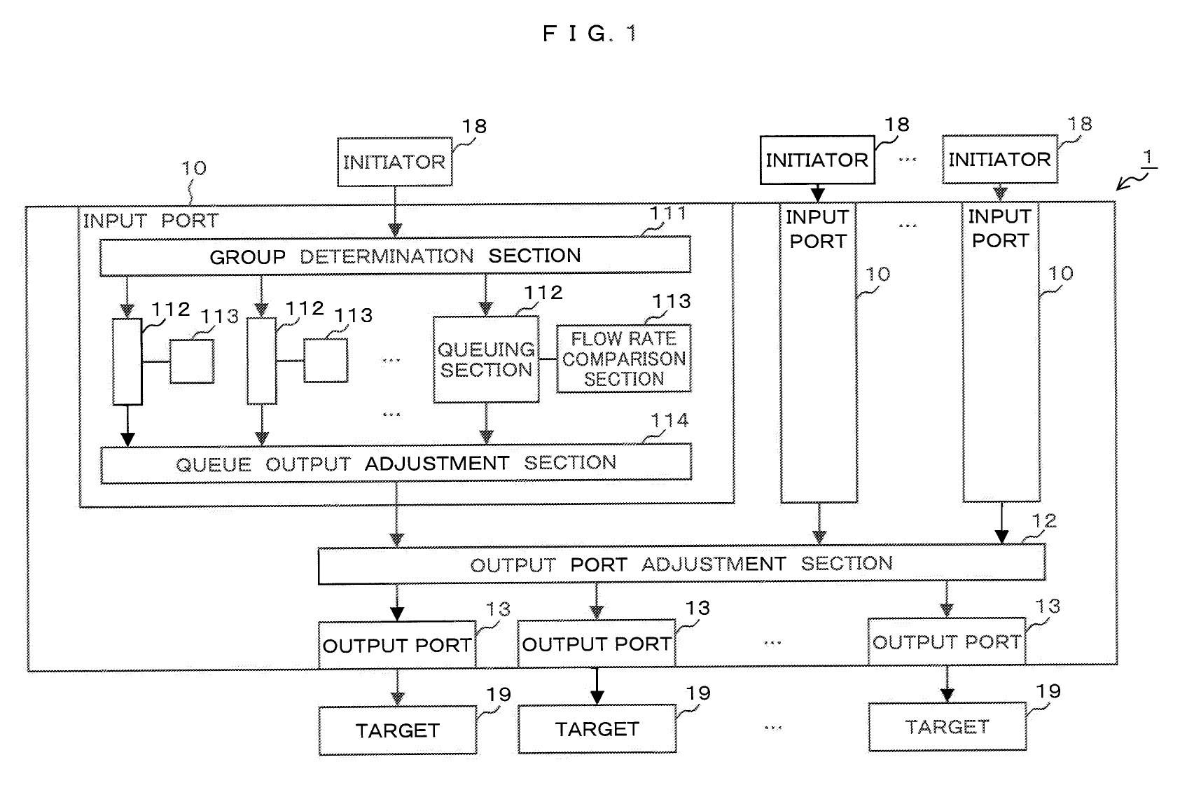

FIG. 1 shows a configuration example of a PCIe switch.

A PCIe switch (hereinafter, simply called “switch”) 1 has a plurality of input ports 10 and a plurality of output ports 13, a plurality of initiators 18 such as computers having a function of generating packets or the like are connected to the respective input ports 10, and a plurality of targets 19 such as I/Os, which are transmission destinations of packets are connected to the respective output ports 13. An output adjustment section 12 is provided between the input ports 10 and the output ports 13 to perform adjustment of outputs of packets to the output ports 13.

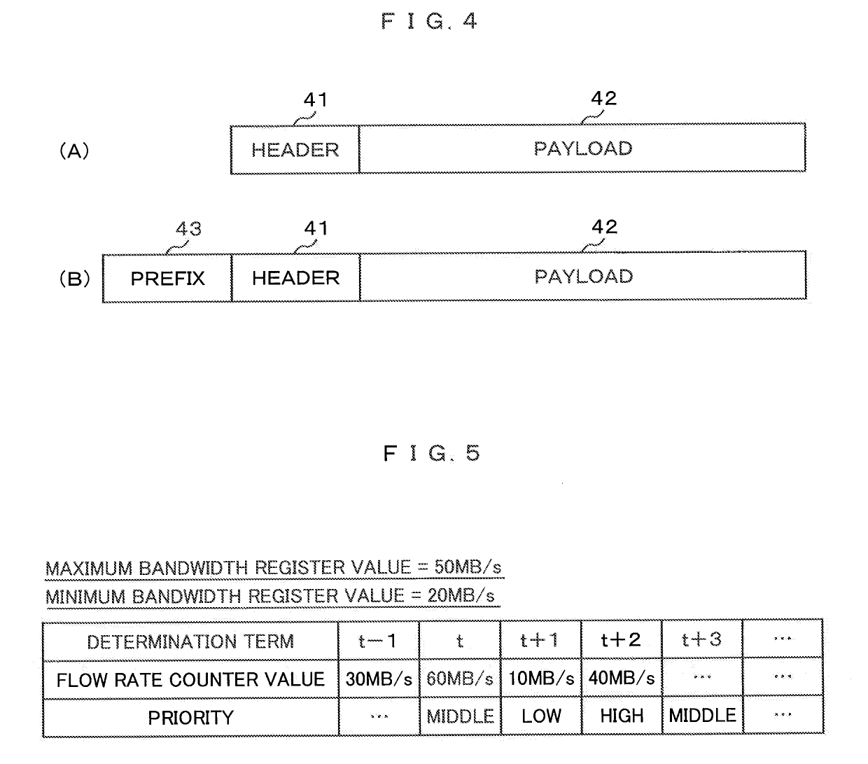

As a PCIe packet handled in this switch 1, there is a packet composed of a header 41 and a payload 42, as shown in FIG. 4(A), and a packet is configured by adding at least one prefix 43 to the header 41 and the payload 42. The header 41 or the prefix 43 represents management information such as the meaning or the destination of a packet, while the payload 42 stores data therein. The packet is generated in the initiator 18 to be outputted to the target 19 via the switch 1.

The input port 10 of the switch 1 is composed of a group determination section 111, a plurality of queuing sections 112, a plurality of flow rate comparison sections 113, and a queue output adjustment section 114. As described later, a bandwidth control function of packets characterizing the present invention is realized by the group determination section 111, the plurality of queuing sections 112, the plurality of flow rate comparison sections 113, and the queue output adjustment section 114.

The group determination section 111 refers to the header 41 or the prefix 43 of packets forwarded from the initiator 18 and inputted into the input port 10 to classify the packet into any of groups according to a predetermined rule. The classified packet is inputted into the queuing section 112 corresponding to the group.

Classification of group is performed on the basis of, for example, a destination which is a forwarding destination of a packet, a forwarding source, a combination of the forwarding destination and the forwarding source, a length of a packet, a function which should be performed by a packet (for example, a read command, a write command or the like), and the like. Specifically, in an address routing packet in PCIe, there are an address field, a requester ID, a length, a format, a packet type, and the like.

Each of the queuing sections 112 and each of the flow rate comparison sections 113 constitute a queue as a set fashion. One queue corresponds to one group, and a plurality of queues exist in one input port 10 so as to correspond to a plurality of groups. That is, the number of sets of the queuing section 112 and the flow rate comparison section 113 is prepared in response to the number of destinations required for bandwidth control.

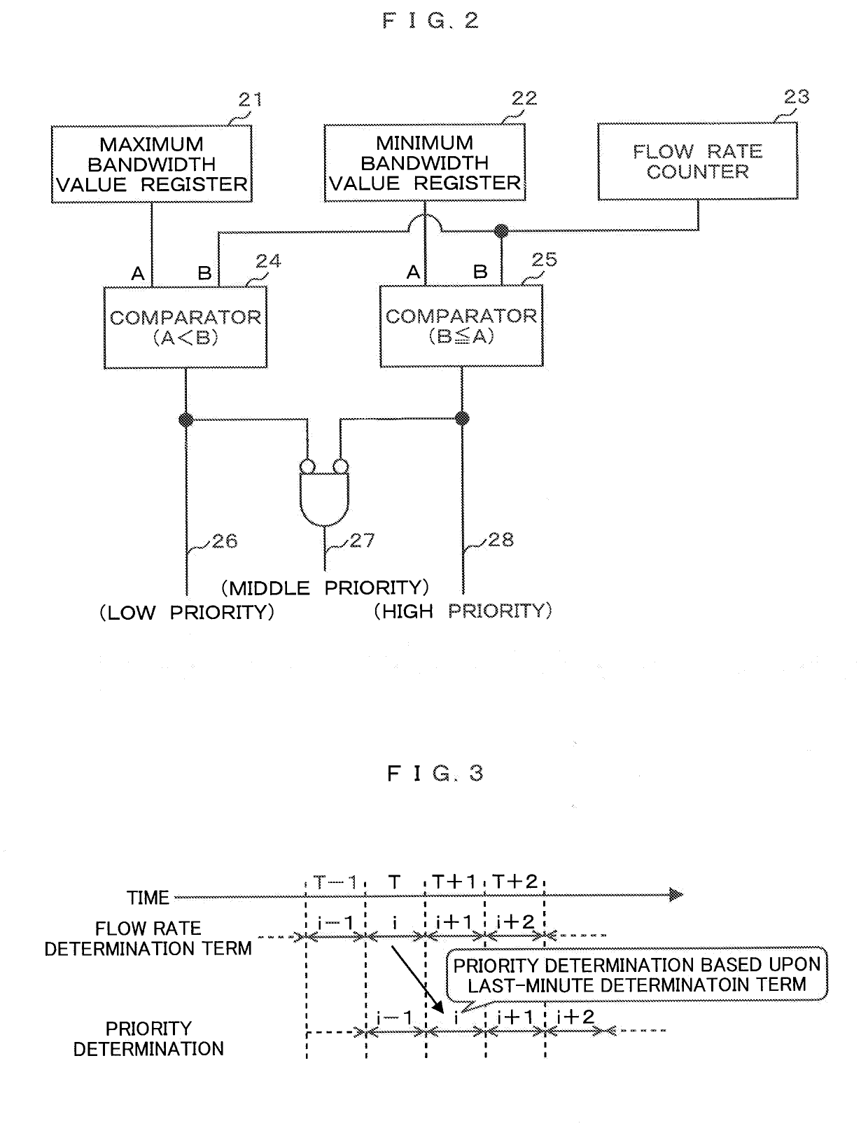

The queuing section 112 is a buffer that stores a packet therein, and receives a packet inputted from the group determination section 111 and outputs the packet to the queue output adjustment section 114. The flow rate comparison section 113 assigns priority to a packet outputted from the queuing section 112 to the queue output adjustment section 114 as additional information. The priority is information for performing bandwidth control of a packet and it is assigned by a priority determination circuit exemplified in FIG. 2 in this Example. A limit value of a bandwidth can be set in a queue composed of the queuing section 112 and the flow rate comparison section 113, and the priority can be determined on the basis of the limit value. The queue output adjustment section 114 performs adjustment on the basis of the assigned priorities when packets outputted from the plurality of queuing sections 112 are outputted to the output port adjustment section 12 and selects a packet outputted to the output port adjustment section 12. Similarly, the output port adjustment section 12 also performs adjustment of packets outputted from the respective input ports 10 on the basis of the priorities to output the packets to the output ports 13.

The flow rate comparison section 113 has a function of assigning priorities to packets stored in the queuing sections 112. As one example, the priority is determined by comparing an output amount per unit time of packets stored in the queuing section 112 and a limit value of bandwidth control set for each queue with each other. By combining the queuing section 112 and the flow rate comparison section 113, the priority can be changed in response to the output amount of packets for each unit time, so that efficient bandwidth control is made possible.

In the PCIe specification, QoS is realized by providing a plurality of VCs and performing independent control to each of VCs. In order to utilize the plurality of VCs, all of an RC, an EP, and a switch connecting the RC and the EP must have a queue, a buffer and a control circuit for controlling these members. In a switch having a bandwidth control function in a preferred example of the present invention, however, the RC and the EP are not required to have a function corresponding to the VC, so that a bandwidth control-adjusted equipment configuration becomes easy for configuring a computer system.

Next, a configuration example of the bandwidth control in the switch 1 will be described with reference to FIG. 2.

FIG. 2 shows a configuration example of a priority determination circuit. The priority determination circuit is provided in each of the flow rate comparison sections 113 of the input port 10. In this example, as the limit value of the bandwidth control, a maximum control value and a minimum control value are involved, and the priority includes three types of a low priority, a middle priority, and a high priority.

The priority determination circuit is provided with a maximum bandwidth value register 21, a minimum bandwidth value register 22, a flow rate counter 23, and comparators 24 and 25 that compare an output of the flow rate counter 23 and an output of the maximum bandwidth value register 21 or the minimum bandwidth value register 22 with each other, and outputs of the comparators 24 and 25 are a low priority signal 26, an middle priority signal 27, or a high priority signal 28.

Here, the maximum bandwidth value register 21 stores a maximum bandwidth limit value therein, while the minimum bandwidth value register 22 stores a minimum bandwidth limit value therein. The maximum bandwidth limit value and the minimum bandwidth limit value can be set from an external terminal by a manager of the switch 1 or the computer system in response to an application to be executed or a data amount to be processed. The timing of the setting may be before execution of an application or during execution thereof.

The flow rate counter 23 measures a flow rate of inputted packets per unit time predetermined by a timer (not shown) to store the flow rate therein. The value of the flow rate register 23 is obtained by calculating a flow rate from the maximum bandwidth of the bus and an actual occupation time or adding lengths written at headers of packets for the respective packets.

The comparators 24 and 25 each determine the low priority when an actual flow rate of packets is more than the maximum bandwidth value, the high priority when the actual flow rate of packets is less than the minimum bandwidth, and the middle priority when the actual flow rate of packets is between the minimum bandwidth and the maximum bandwidth.

The queuing section 112 assigns the priorities to the packet to output the packets in response to the determination results of these comparators 24 and 25. In the queue output adjustment section 114 and the output port adjustment section 12, adjustment is performed according the assigned priorities to determine the packets to be outputted to the target 19.

Incidentally, in the illustrated example, the priority is classified into three stages of the high priority, the middle priority, and the low priority, but the present invention is not limited to the classification and the priority may be classified to any number of stages. In this example, as the limit value, classification of three stages is adopted by setting the maximum bandwidth register and the minimum bandwidth register, but classification of four stages may be adopted, for example, by providing another bandwidth storage register additionally.

FIG. 3 shows one example of a time relationship between a flow rate determination term and a priority determination.

FIG. 3 shows a case where a priority determination of time T+1 is performed using the result of a flow rate determination term i of time T. In this example, the flow rate determination term and the term of the priority determination have the same time interval, but they may be actually different from each other. By setting the flow rate determination term and the term of the priority determination to the same time interval, one timer can be shared. Further, by making the flow rate determination term longer than the priority determination term, the priority can be made insusceptible to influence from instantaneous fluctuation of the flow rate.

In the priority determination circuit (FIG. 2), the determination term is measured by a timer. The flow rate counter is cleared at a starting time of the determination term, a flow rate of packets within the determination term is measured. A flow rate per unit time is obtained on the basis of the value of the flow rate counter measured regarding the term defined by the timer to be set in the flow rate storage register. Thus, when packets are outputted from the queuing section 112, information about the priority can be assigned to the packets.

Next, the priority determination and the assignment of the priority information to a packet will be described on the basis of the configuration shown in FIG. 2 with reference to FIG. 5. The value of the maximum bandwidth register is set to 50 MB/s, while the value of the minimum bandwidth register is set to 20 MB/s. When the value of the flow rate counter for the determination term t−1 is 30 MB/s, the priority of the determination term t becomes the middle priority, so that information of the middle priority is assigned to packets outputted from the queuing section 112 during the determination term t. Next, when the value of the flow rate counter for the determination term t is 60 MB/s, the priority of the determination term t+1 becomes the low priority, so that information of the low priority is assigned to packets outputted from the queuing section 112 during the determination term t+1. Further, when the value of the flow rate counter for the determination term t+1 is 10 MB/s, the priority of the determination term t+2 becomes the high priority, so that information of the high priority is assigned to packets outputted from the queuing section 112 during the determination term t+2. When the value of the flow rate counter for the determination term t+2 is 40 MB/s, the priority of the determination term t+3 becomes the middle priority, so that information of the middle priority is assigned to packets outputted from the queuing section 112 during the determination term t+3.

The queue output adjustment section 114 forwards a packet having higher priority to the output port adjustment section 112 while referring to packets inputted from the queuing section 112 and their priorities. When a plurality of packets having the same priority exist, output requests of packets having the same priority can be processed in order by a round-robin processing or the like. When packets having the middle priority and the high priority do not exist in the queue output adjustment section 114, the set maximum bandwidth value can be maintained by suppressing outputs of the packets having the low priority. Further, another idea, when the packets having the middle priority and the high priority do not exist, the bandwidth can utilized effectively by inhibiting suppression of outputs of the packets having the low priority.

When only the bandwidth control based upon the above-described priority is performed, for example, if packets having the high priority continue to be supplied from a queuing section 112 to the queue output adjustment section 114, packets having the middle priority or the low priority are prevented from being outputted from another queuing section 112 to the queue output adjustment section 114. In order to avoid such a situation, for example, an output monitoring function is imparted to the queuing section 112, so that if a packet which is not outputted even after a certain time has elapsed exists in the queuing section, control is performed so as to raise the priority of the packet. That is, such a control is proposed that, if a packet whose priority has been determined as the low priority in the queuing section 112 has not been outputted even when Δ term has elapsed, the priority of the packet is changed from the low priority to the middle priority upon elapse of the Δ term, and when the packet has not been outputted even when Δ term has further elapsed, the priority of the packet is changed to the high priority.

As another example, such a method is proposed that, if the packet having the middle priority or the low priority, which transitions to have the high priority and is not outputted from the queuing section 112 even when a certain time has elapsed exists, once the priority of the packet which is not outputted is lowered in order not to stop a packet in another queue of the queue output adjustment section 114, a packet in the another queue is selected.

Like the queue output adjustment section 114, while referring to packets inputted from the queue output adjustment section 114 and their priorities, the output port adjustment section 12 forwards a packet having a higher priority to the output port 13. When a plurality of packets having the same priority exist, output requests of packets having the same priority can be processed in order by a round-robin processing or the like.

With a configuration as described above, it is made possible to realize a PCIe switch having a bandwidth control function. As a result, a bandwidth usable between applications sharing a target can be set, so that a data forwarding performance of an entire system can be made optimal. Further, since the bandwidth control can be realized by the PCIe switch, an existing computer or device which does not have a bandwidth control function can be used in a computer system connecting a plurality of computers and a plurality of devices via a switch.

### Embodiment 2

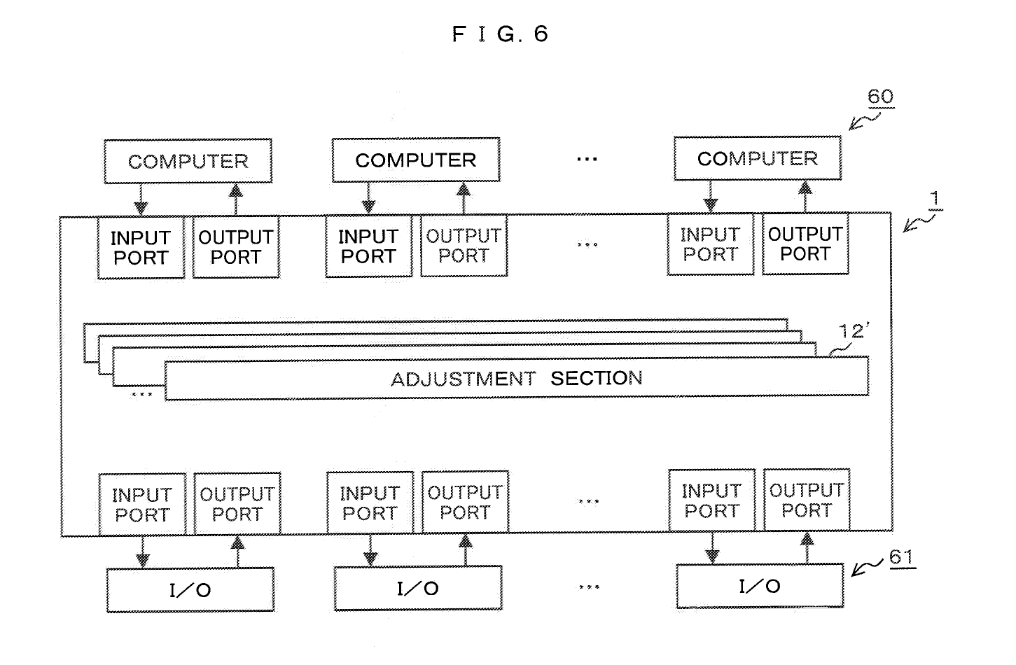

FIG. 6 shows a configuration example of a computer system equipped with a switch provided with a bandwidth control function.

The computer system is configured by connecting a plurality of computers 60 and a plurality of I/O devices 61 to input ports and output ports of a switch 1 provided with the above-described bandwidth control function. Each of the computers and the I/O devices functions as an initiator 18 that generates packets or a target 19 which is a destination of the packet. Here, the switch 1 provided with the bandwidth control function is provided with adjustment sections 12′ in response to combinations of an input port and an output port to perform bandwidth control.

Thus, since the bandwidth control can be realized by the PCIe switch 1, it is unnecessary to provide a function of performing the bandwidth control in a computer or an I/O device itself connected to the computer system, so that an existing computer or device which does not have the bandwidth control function can be connected freely.

### Embodiment 3

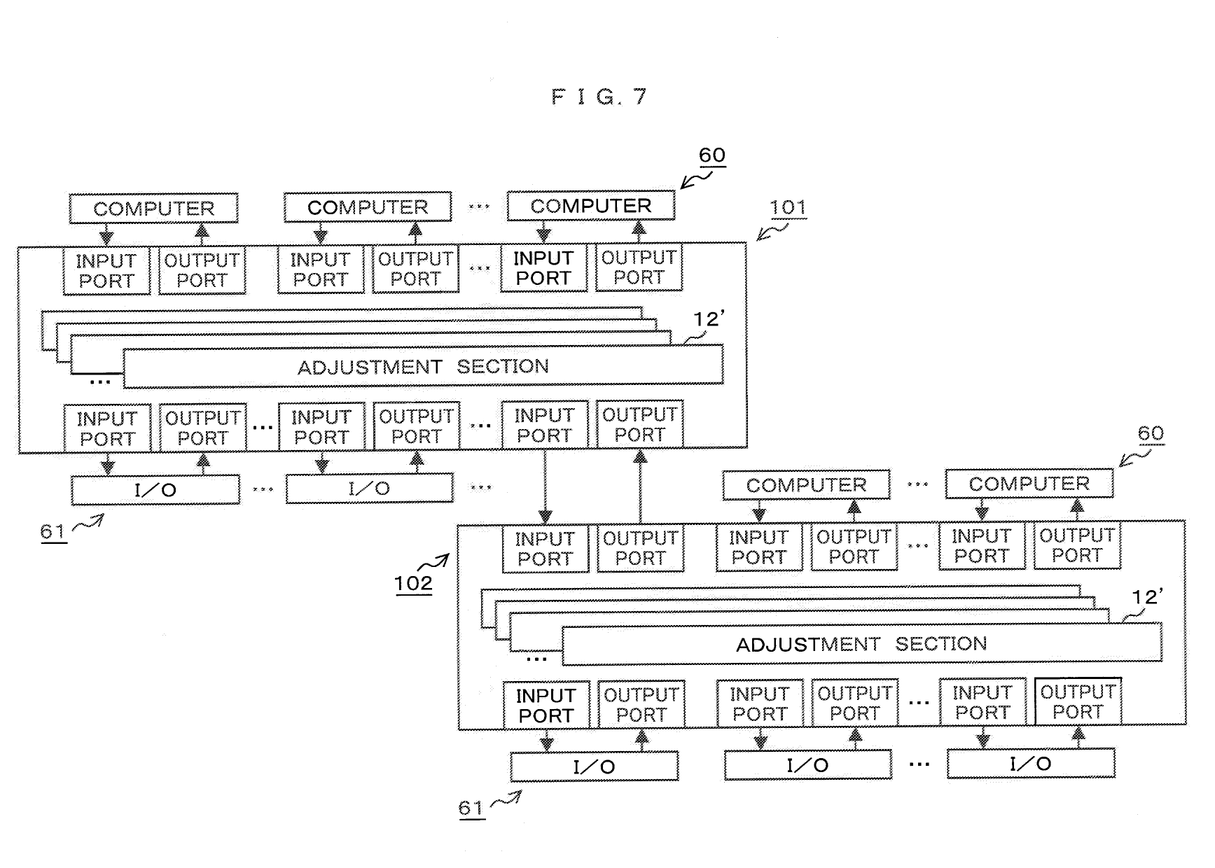

FIG. 7 shows a configuration example of a computer equipped with switches having a bandwidth control function in a multistage fashion.

The example shown in FIG. 6 is directed to the switch having a one-stage configuration, while the example shown in FIG. 7 is directed to the switches configured in the multistage fashion. That is, a two-stage configuration is realized by connecting, to input/output ports of the switch 101 configured as shown in FIG. 6, output/input ports of a switch 102 having a configuration similar to that of the switch 101. Similarly, a multistage switch configuration can be realized by sequentially connecting other output/input ports of another switch to input/output ports of the switch 102. In each switch, by setting a control value of a queue such as shown in Example 1, a computer system to which a computer or an I/O device can be freely connected can be realized like Example 2.

When a switch having a multistage configuration is adopted, input ports of the subsequent stage switch 102 receive packets from a plurality of initiators (computers or I/O devices) connected to the previous stage switch 101. Therefore, if the determination processing in the group determination section 111 is performed in the same manner as the one-stage configuration, such a case that queues allocated at a classification time into groups are biased may occur. For example, when classification into 8 groups from group A to group H is performed by group determination in the group determination section 111 of the previous stage switch 101 and outputs of the groups A to D are directed to the subsequent stage targets, only the groups A to D are substantially used at the input ports of the subsequent stage switch 102, so that the queues in the groups E to H go to waste.

Therefore, it is preferable to change the method of the group determination at the input ports of the subsequent stage switch 102 in the multistage configuration. Specifically, exclusive OR of the initiator ID constituting a generating source of packets and the target ID constituting a forwarding destination is obtained and a value thereof is used for the group determination, so that it is possible to prevent bias of queues at the classification time into groups.

### REFERENCE SIGNS LIST

1: PCIe switch
18: initiator
19: target
10: input port
111: group determination section
112: queuing section
113: flow rate comparison section
114: queue output adjustment section
13: output port
21: maximum bandwidth value register
22: minimum bandwidth value register
23: flow rate counter
24, 25: comparator
60: computer
61: I/O device
12: adjustment section
101, 102: PCIe switch

1. A switch that connects initiators that generate packets and targets which are transmission destinations of the packets, the switch comprising:
input ports to which the initiators are connected; output ports to which the targets are connected; and an output port adjustment section intervening between the input ports and the output ports, for adjusting the output of packets from the input ports to the output ports, wherein
the input ports further have a bandwidth control section that establishes bandwidth limit values beforehand for each of a plurality of divided groups; classifies packets transmitted from the initiators into any of the plurality of groups according to a predetermined rule; and outputs the classified packets to the output port adjustment section, on the basis of the bandwidth limit values.

2. The switch according to claim 1, wherein the bandwidth control section determines priority of the group, on the basis of the bandwidth limit values established beforehand and a flow rate of packets measured for a predetermine term, from a usage bandwidth at a time point before the measurement to perform outputs of the packets on the basis of the determined priority.

3. The switch according to claim 1, wherein the bandwidth control section performs control so as to raise the priority of the group that does not output a packet for a certain term.

4. The switch according to claim 1 wherein the bandwidth control section performs control so as to raise or lower the priority of the group that does not output a packet for a certain term with respect to each certain term.

5. The switch according to any claim 1, wherein each of the packets is composed of a header having a field showing a transmission destination of the packet, a transmission source of the packet, a length of the packet, a processing function to be performed by the packet, and a payload that holds forwarding data, and
the bandwidth control section classifies the inputted packets into any of groups on the basis of the transmission destination of the packet, the transmission source of the packet, the combination of the transmission destination and the transmission source, the processing function to be performed by the packet, and a combination thereof,
sets a maximum bandwidth limit value and a minimum bandwidth limit value of the bandwidth for each group,
measures a usage bandwidth of the packet from an occupation time of a bus or a usage bandwidth of the packet from a length managed by the header,
when the usage bandwidth exceeds the maximum bandwidth limit value, determines the priority as a low priority, when usage bandwidth is between the maximum bandwidth limit value and the minimum bandwidth limit value, determines the priority as a middle priority, and when the usage bandwidth is less than the minimum bandwidth limit value, determines the priority as a low priority, thereby assigning the determined priorities to the packets, respectively, and
consequently identifies the priorities of the packets for each group and selects a packet having a higher priority to output the same to the output port adjustment section.

6. The switch according to claim 5, wherein the bandwidth control section raises the priority of the group which does not output a packet for a certain term, once lowers the priority of a packet which has reached the highest priority but is not outputted for a certain term, and raises the priority of the packet again after a fixed time.

7. The switch according to claim 1, wherein the switch is a switch based upon a PCIe specification, and
the bandwidth control section performs a bandwidth control of a PCIe packet that has a header representing management information of the packet and a payload that holds data.

8. The switch according to claim 1, wherein the packet is a PCIe packet composed of a header having a field showing a transmission destination of the packet, a transmission source of the packet, a length of the packet, a processing function to be performed by the packet, and a payload holding forwarding data, and
the bandwidth control section
classifies the packets to be inputted into any of groups on the basis of the transmission destinations of the packets,
sets a maximum bandwidth limit value and a minimum bandwidth limit value of the bandwidth for each of the groups,
computes a packet length from a payload length managed by the header and a length of the header itself, holds the sum of packet lengths of packets which have been outputted for a fixed time indicated by a timer, thereby measuring a usage bandwidth per unit time,
when the usage bandwidth exceeds the maximum bandwidth limit value, determines the priority as a low priority, when usage bandwidth is between the maximum bandwidth limit value and the minimum bandwidth limit value, determines the priority as a middle priority, and when the usage bandwidth is less than the minimum bandwidth limit value, determines the priority as a low priority, thereby assigning the determined priorities to the packets, respectively, and
identifies the priorities of the packets between the groups of the input port, after selecting packets having a higher priority, identifies the priorities of the packets from each input port at the output port and selects a packet having a higher priority to forward the same to the output port adjustment section.

9. A switch based upon a PCIe specification, which connects initiators that generate packets and targets that are transmission destinations of the packets, the switch comprising: a plurality of input ports to which the initiators are connected; a plurality of output ports that the targets are connected; and an output port adjustment section intervening between the input ports and the output ports, for adjusting the output of PCIe packets from the input ports to output ports, wherein
the plurality of input ports each comprise:
a group determination section classifying PCIe packets transmitted from the initiators into any of a plurality of groups according to a predetermined rule;
a plurality of queuing sections corresponding to the respective groups, for storing the PCIe packets determined by the group determination section;
a plurality of flow rate comparison sections corresponding to the respective groups, for assigning the priorities to the PCIe packets in the queuing section on the basis of bandwidth limit values established beforehand to perform bandwidth control; and
a queue output adjustment section performing adjustment of the PCIe packets outputted from the queuing section on the basis of the priorities assigned by the flow rate comparison section, and wherein
the PCIe packets outputted from the queue output adjustment section are forwarded to the output port adjustment section.

10. A computer system comprising:
a switch based upon a PCIe specification and having plurality of input ports, a plurality of output ports, and an output port adjustment section that performs adjustment of output of packets from the input ports to the output ports;
a plurality of computers connected to the input ports and the output ports, and serving as initiators that generate packets or targets that are transmission destinations of the packets; and
a plurality of I/O devices connected to the input ports and the output ports, and serving as initiators that generate packets or targets that are transmission destinations of the packets, wherein
the input ports of the switch have a bandwidth control section that establishes bandwidth limit values beforehand for each of a plurality of divided groups, classifies packets transmitted from the initiators into any of the plurality of groups according to a predetermined rule, and outputs the classified packets to the output port adjustment section, on the basis of the bandwidth limit values.

11. The computer system according to claim 10, wherein
the computers are computers which do not have a bandwidth control function, and
the I/O devices are devices which do not have a bandwidth control function.

12. The computer system according to claim 10, wherein a pair of input port and output port of the switch is further connected with another switch having a configuration similar to that of the former switch, and a plurality of input ports and a plurality of output ports of the another switch are connected with a plurality of computers and I/O devices.

13. A PCIe packet forwarding control method in a switch based upon a PCIe specification and having plurality of input ports, a plurality of output ports, and an output port adjustment section that performs adjustment of output of packets from the input ports to the output ports, the method comprising:
a group determination step of classifying PCIe packets transmitted from the initiators into any of a plurality of groups according to a predetermined rule;
a step of storing the PCIe packets determined in the group determination step in a storage means;
a step of assigning priorities to the PCIe packets in the storage means on the basis of bandwidth limit values established beforehand to perform bandwidth control;
a step of performing adjustment of the PCIe packets outputted from the storage means on the basis of the priorities assigned; and
a step of transmitting the adjusted PCIe packets from the output ports to the targets which are the transmission destinations via the output port adjustment section.

14. The PCIe packet forwarding control method according to claim 13, wherein said bandwidth control determines priority of the group, on the basis of the bandwidth limit values established beforehand and a flow rate of packets measured for a predetermine term, from a usage bandwidth at a time point before the measurement to perform outputs of the packets on the basis of the determined priority.

15. The PCIe packet forwarding control method according to claim 13, wherein said bandwidth control performs control so as to raise the priority of the group that does not output a packet for a certain term.

16. The PCIe packet forwarding control method according to claim 13, wherein said bandwidth control performs control so as to raise or lower the priority of the group that does not output a packet for a certain term with respect to each certain term.

17. The PCIe packet forwarding control method according to claim 13, wherein each of the packets is composed of a header having a field showing a transmission destination of the packet, a transmission source of the packet, a length of the packet, a processing function to be performed by the packet, and a payload that holds forwarding data, and
said bandwidth control classifies the inputted packets into any of groups on the basis of the transmission destination of the packet, the transmission source of the packet, the combination of the transmission destination and the transmission source, the processing function to be performed by the packet, and a combination thereof, sets a maximum bandwidth limit value and a minimum bandwidth limit value of the bandwidth for each group,
measures a usage bandwidth of the packet from an occupation time of a bus or a usage bandwidth of the packet from a length managed by the header,
when the usage bandwidth exceeds the maximum bandwidth limit value, determines the priority as a low priority, when usage bandwidth is between the maximum bandwidth limit value and the minimum bandwidth limit value, determines the priority as a middle priority, and when the usage bandwidth is less than the minimum bandwidth limit value, determines the priority as a low priority, thereby assigning the determined priorities to the packets, respectively, and consequently identifies the priorities of the packets for each group and selects a packet having a higher priority to output the same to the output port adjustment section.

18. The PCIe packet forwarding control method according to claim 17, wherein the bandwidth control raises the priority of the group which does not output a packet for a certain term, once lowers the priority of a packet which has reached the highest priority but is not outputted for a certain term, and raises the priority of the packet again after a fixed time.

19. The PCIe packet forwarding control method according to claim 13, wherein the switch is a switch based upon a PCIe specification, and
the bandwidth control performs a bandwidth control of a PCIe packet that has a header representing management information of the packet and a payload that holds data.
